(19) United States
(12) Patent Application Publication
(10) Pub. No.: US 2010/0171300 A1
(43) Pub. Date: Jul. 8, 2010

(54) Housing For A Tube Coupling

(75) Inventor: Damir Sudar, Bad Ragaz (CH)

Correspondence Address: HODGSON RUSS LLP;THE GUARANTY BUILDING, 140 PEARL STREET, SUITE 100, BUFFALO, NY, 14202-4040, US

(73) Assignee: STRAUB WERKE AG, Wangs (CH)

(21) Appl. No.: 12/307,400

(22) PCT Filed: Jul. 2, 2007
(86) PCT No.: PCT/IB07/52564

§ 371 Date: May 15, 2009

(30) Foreign Application Priority Data
Jul. 6, 2006 (CH) 01089/06

(51) Int. Cl. F16L 21/06; B23P 17/00; B23K 11/00; B23K 11/10

(52) U.S. Cl. 285/37; 29/592; 219/78.01; 219/91.2

(57) ABSTRACT

A tube coupling apparatus comprises an essentially cylindrical housing (11), for a tube coupling for connecting smooth ended tubes (16, 17), in particular, for axially strong connections with a gap (12), a one-piece molded tongue (7), bridging the gap (12), tightening straps (9, 9′) arranged to both sides of the gap (12) to accommodate closing bolts (12, 13) arranged parallel to the axis and tightening nuts (14) connected thereto, for radial tightening of the tube coupling. The housing (11) is made from flat strip material (1) and the tightening straps (9, 9′) are connected in one piece to the housing (11).

### CROSS-REFERENCE TO RELATED APPLICATIONS

The present application is the U.S. National Phase of International Application No. PCT/IB2007/052564 filed Jul. 2, 2007, which claims priority of Swiss Application No. 01089/06 filed Jul. 6, 2006.

### FIELD OF THE INVENTION

The invention relates to a substantially cylindrical housing (11) for a tube coupling for connecting smooth-ended tubes (16, 17), in particular for connections with high axial tensile strength, comprising a gap (12), an integrally formed-on tongue (7), which bridges the gap (12), tightening straps (9, 9′), arranged on both sides of the gap (12), for the reception of locking bolts (13, 13′) arranged axially parallel to each other, and clamping screws (14), connected thereto, for the radial clamping of the tube coupling, wherein the tightening straps (9, 9′) are integrally connected to the housing (11) and the housing (11) consists of flat strip material (1) and the housing (11), viewed in the axial direction, has perforations (2) in the central region.

### BACKGROUND OF THE INVENTION

With the aid of tube couplings of said type, smooth-ended tubes, tube sections, such as, for example, tube bends and T-pieces and fittings, can be joined together and also rapidly unfastened again. In this context, a distinction is drawn between tube couplings which have high axial tensile strength and those which do not. Couplings with high tensile strength can absorb axial forces which are created by the internal pressure of the line medium or generated by external force influences. By contrast, couplings without high axial tensile strength serve exclusively for the sealing of the tube joint and are incapable of absorbing axial forces.

In the case of the from CH 666 949, the tightening straps are integrally connected to the housing. The tongue bridging the gap of the housing consists of spring steel, is manufactured as a separate part, is inserted in the housing and is secured against displacement.

In the case of tube couplings known from WO 2005/022020, the tongue is integrally formed onto the housing. By contrast, the tightening straps are manufactured as separate parts and are joined to the housing by welding, for example.

In these tube couplings, both the housing itself and the tongue and tightening straps, for corrosion protection reasons, generally consist of stainless steel. These materials are very expensive and are laborious to process. Since the strength of non-spring steels is relatively low, large wall thicknesses are necessary to absorb the forces which arise. This has an adverse effect both upon the weight of the tube coupling and upon the price.

GB 706,899 discloses a clamp, in particular for hoses, in which the tongue, the straps and that part of the housing which embraces the hose consist of a single strip-shaped piece. The strip has in the central region two slots running in the longitudinal direction of the strip and configured as perforations. These slots serve for the passage of the pivotable clamping screw, or serve as a pivotable counterbearing to the locking mechanism for the tightening of the clamp.

### SUMMARY OF THE INVENTION

The object of the invention is to provide a tube coupling which is cheap and simple to manufacture and fit and which has a certain deformability of the housing.

According to the invention, this is achieved by configuring the perforations as axially running slots with residual intervening webs, which webs form a crumple zone. Depending on the stress (on the traction or pressure side of the housing), the webs can be stretched or compressed.

As a result of temperature changes (due to dilations) or external force influences (in particular bending stresses), very high forces and moments can be generated on the housing, which can lead to a failure of the tube coupling. The perforations form weak points, which allow deformation of the housing in the central region.

In order to prevent stress concentration factors resulting from sharp edges, it is expedient if the slots are oval in configuration. Moreover, oval slots also produce longer tool lives in respect of the punching tools, since the wear is more uniform and less pronounced.

The perforations, or slots, and webs advantageously extend over the whole of the periphery of the housing. The housing is thus always deformable in roughly equal measure in virtually every installation position. A further advantage consists in the fact that the raw material is punched in endless formation from a strip and can be laid in stock for equal coupling widths.

The width of the webs between the individual slots, or perforations, is expediently less than the width of the slots, or perforations. Good deformability of the remaining webs is thereby ensured.

The inventive one-piece configuration of the housing means that the housing can consist of spring steel. Spring steel has substantially higher strength and elasticity compared to normal stainless steels. Material and weight savings, as well as a considerable cost reduction, are thereby possible.

The manufacture of the housing is advantageously realized as follows: in a first step the perforations are punched into continuous strip material, in a further step, in accordance with the desired diameter of the housing, pass-through openings for the clamping screws are made at an appropriate distance apart, the blank is cut off from the rest of the strip material to the necessary length, the strip material is shaped as a circular loop, this then is deformed into two opposing, mutually connected straps and is then rounded into the finished housing.

At the connecting point of the two straps, the walls of the housing, which lie one on top of the other, are expediently joined together.

This joining of the walls is preferably realized by resistance welding, for example by spot welding.

Further configurations of the invention are defined in the figures and in the dependent patent claims.

The reference symbol list is a constituent part of the disclosure.

### BRIEF DESCRIPTION OF THE DRAWINGS

The invention is explained symbolically and illustratively in greater detail with reference to figures.

The figures are described in a coherent and overlapping manner. Identical reference symbols signify identical parts, reference symbols with different indices indicate components that are similar or have the same function.

FIG. 1 shows a piece of prepunched strip (raw) material (continuous),

FIG. 2 shows a part-piece, which has been cut to length as a blank in accordance with the nominal diameter,

FIG. 3 shows the part-piece according to FIG. 2, with a region rolled up into a loop,

FIG. 4 shows the part-piece according to FIG. 3, with a loop deformed into two mutually opposing straps and with a tongue bent up in the direction of the opposing side,

FIG. 5 shows an end-face perspective view of the housing rounded into a cylindrical body,

FIG. 6 shows a perspective oblique view of the housing according to FIG. 5,

FIG. 7 shows an end-face projection of the housing, with inserted locking parts, and

FIG. 8 shows a tube coupling with high axial tensile strength and having a housing according to the invention which has been partially deformed due to alignment of the connected tubes.

### DETAILED DESCRIPTION OF THE INVENTION

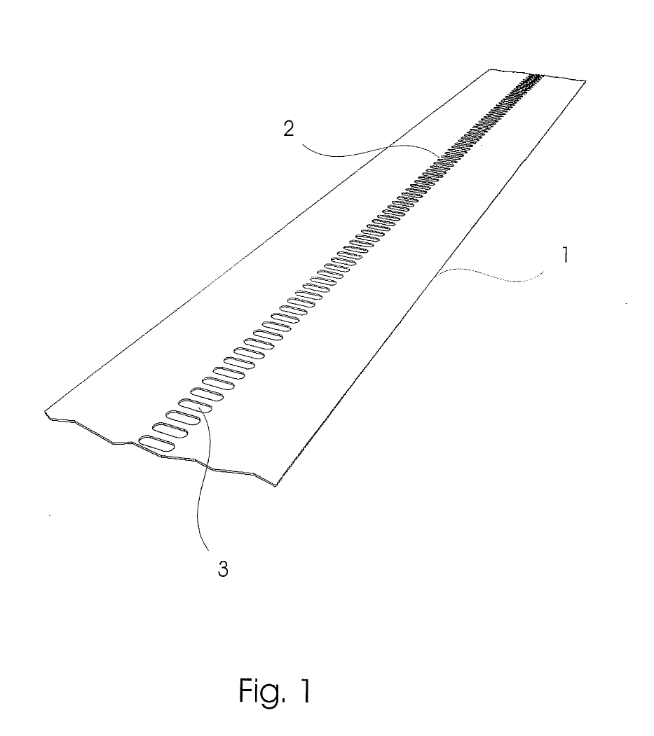

FIGS. 1 to 5 show the various steps in the manufacture of a housing 11 according to the invention. In FIG. 1, a perforation 2 is made in the middle of strip material 1. This perforation is configured, for example, as slots 3 running transversely to the longitudinal direction (i.e. in the finished housing, in the axial direction). After this punching operation, the strip material can then be rolled up again and temporarily stored in a space-saving manner until further treatment.

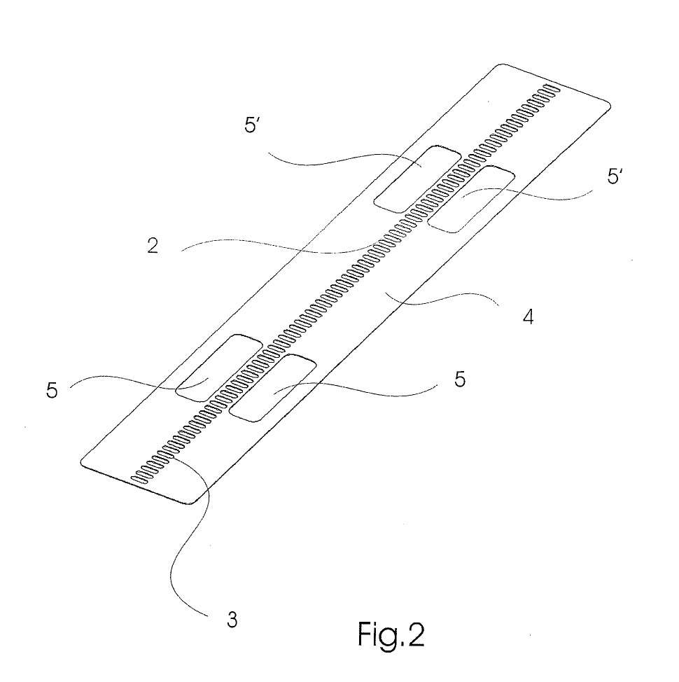

This further treatment can be seen from FIG. 2. Here, the strip material is cut off from the strip material to the length which is appropriate to the nominal diameter of the finished tube coupling. At the same time or subsequently, openings 5, 5′ are made for the passage of the clamping screws, or tools necessary for the clamping of the tube coupling.

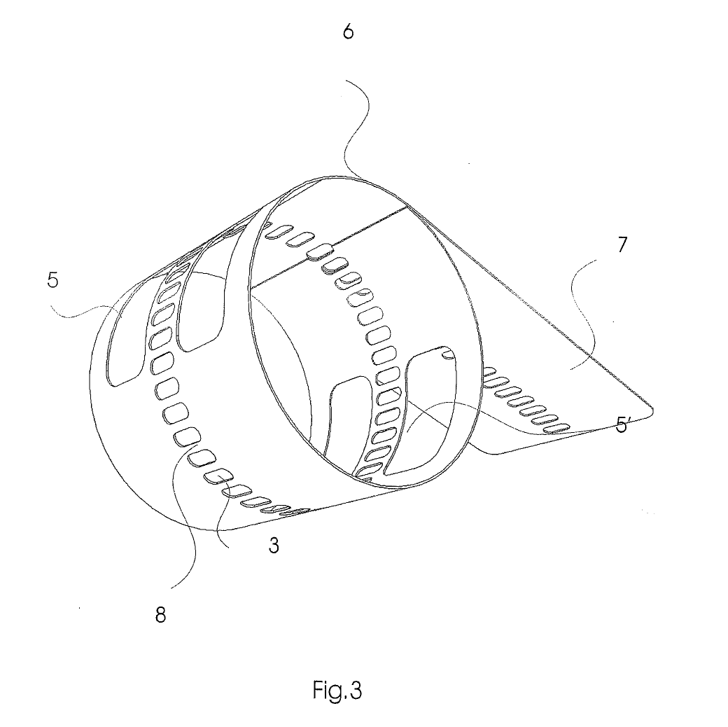

In FIG. 3, the flat strip material is rolled up from one end into a loop 6. The other end forms the tongue 7, which in the end state bridges the gap 12 between the straps.

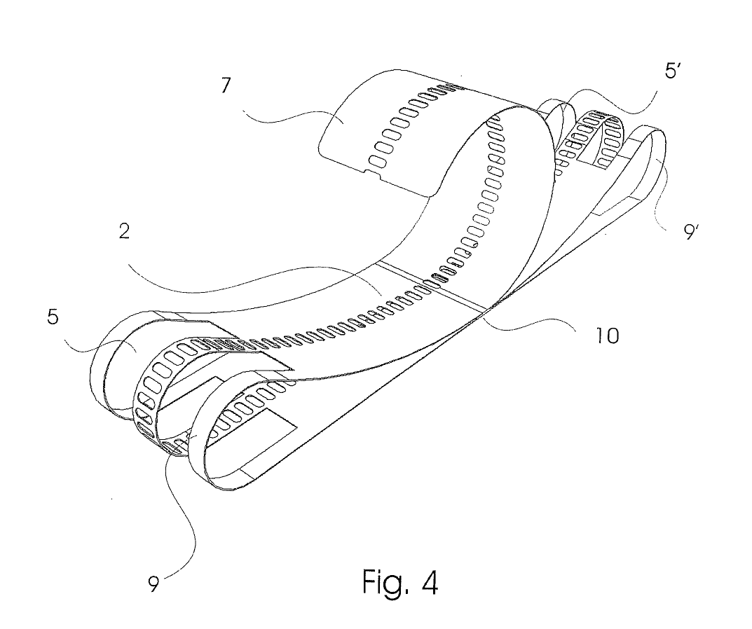

In FIG. 4, the loop 6 is pressed flat in the middle. Two mutually opposing tightening straps 9, 9′ are now formed. At the contact point or connecting point 10, the strip materials are joined together, for example, by a resistance welding, preferably by spot welding. The free end is bent up away from the tightening straps 9, 9′ into a tongue 7.

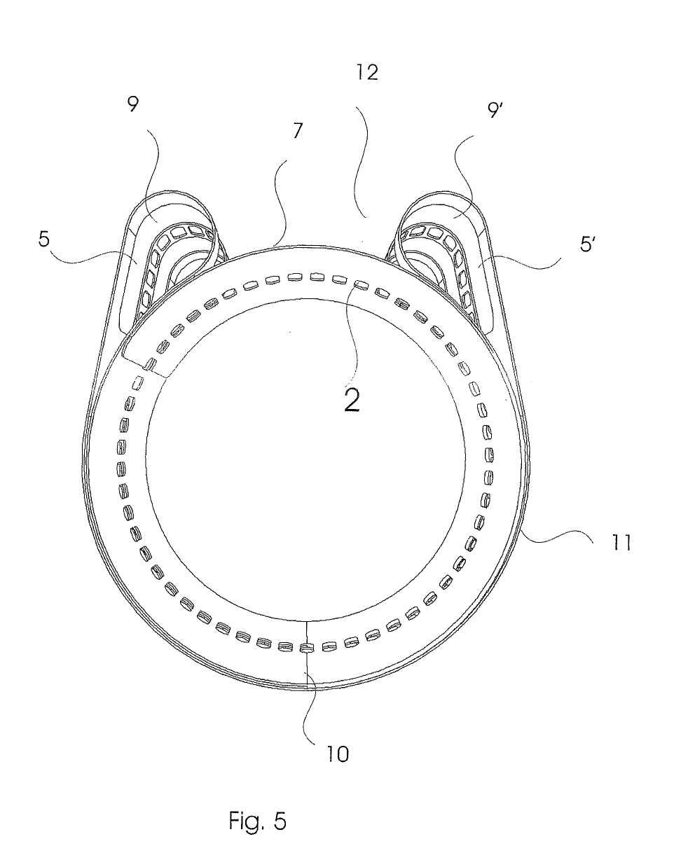

In FIG. 5, the two tightening straps 9, 9′ are bent upward one toward the other around the curved tongue 7. From this view, it becomes clear that the tongue 7 covers the gap 12 remaining between the two tightening straps 9, 9′.

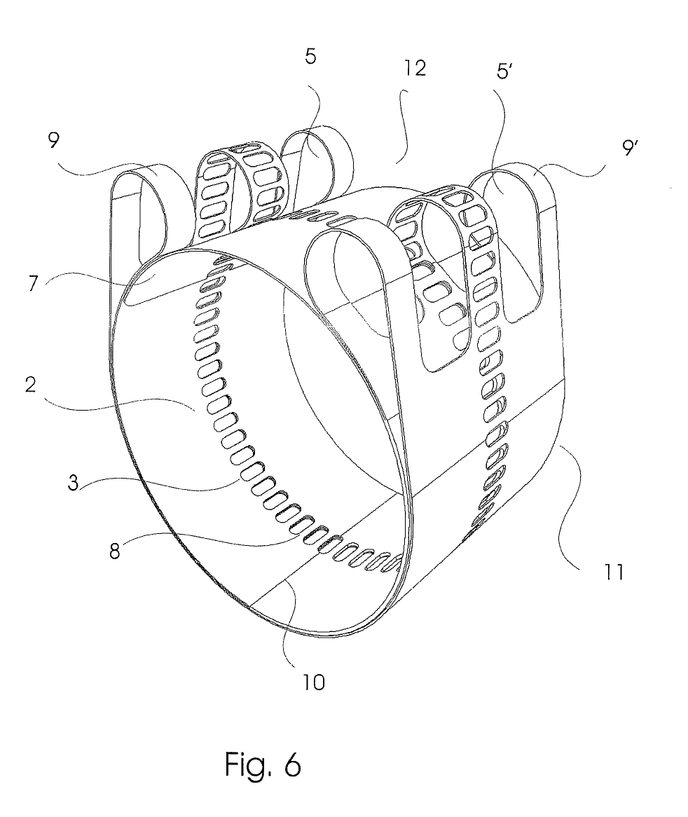

From FIG. 6, the straps 9, 9′ with the openings 5, 5′ for the clamping screws and, in particular, the perforation 2, consisting of slots 3 and residual intervening webs 8, are more clearly discernible.

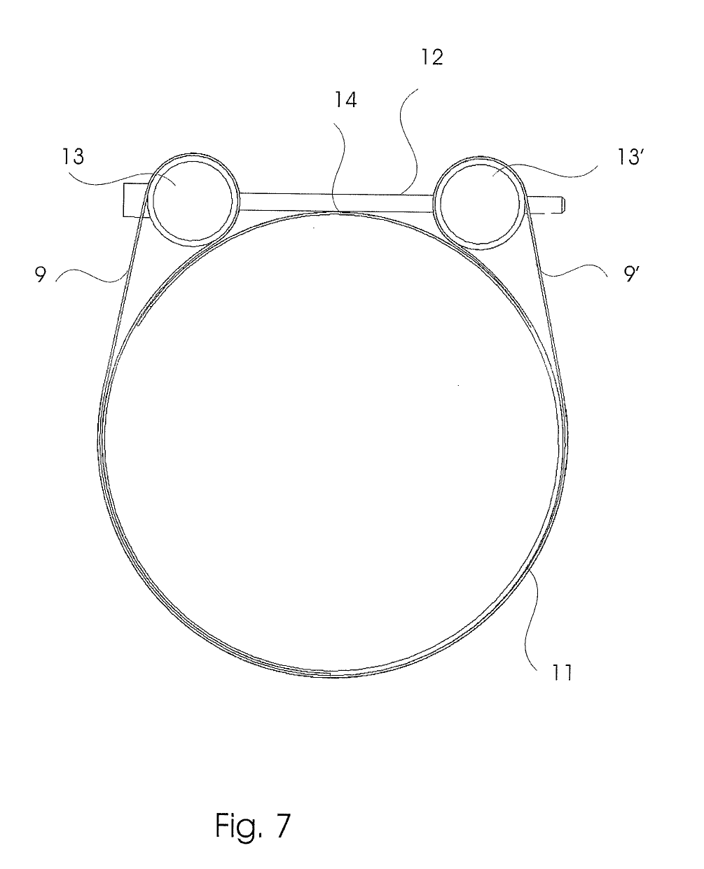

FIG. 7 shows, in somewhat schematic representation, the housing 11 with the tightening straps 9, 9′, the bolts 13, 13′ inserted therein, and the clamping screws 14.

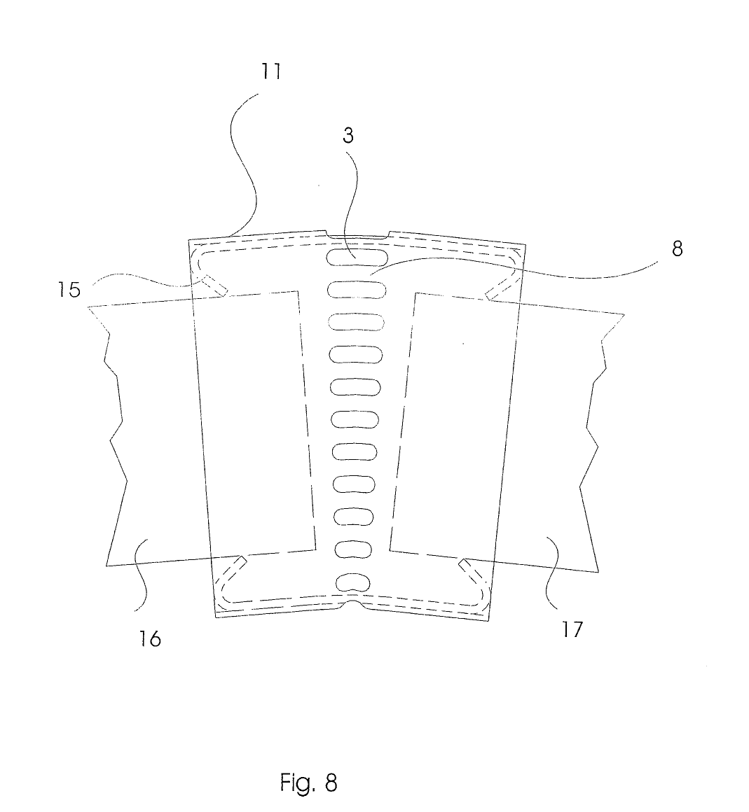

From FIG. 8, a tube coupling clamped onto two tubes 16, 17 and having the housing 11 according to the invention, can be seen. In the represented alignment of the tubes 16, 17, the housing 11 is stretched on the traction side and compressed on the pressure side. The webs 8 remaining between the slots 3 are here correspondingly deformed. The force closure between the two tubes 16, 17 can be realized, for example, by an anchoring element 15 known from CH (Swiss) patent application 0485/05, or International Patent Application PCT/IB2006/050807, published as WO 2006100628.

### REFERENCE SYMBOL LIST

1 strip material
2 perforation
3 slot
4 blank
5, 5′ opening
6 loop
7 tongue
8 web
9, 9′ tightening strap
10 connecting point
11 housing
12 gap
13, 13′ bolt
14 clamping screw
15 anchoring element
16, 17 tube

1.-8. (canceled)

9. A tube coupling apparatus for connecting smooth-ended tubes, the apparatus comprising:
a substantially cylindrical housing (11) formed of a flat strip of material, the housing (11) having a plurality of perforations in an axially central region of the housing (12);
a pair of tightening straps (9, 9′) on opposite sides of the housing (11), the tightening straps (9, 9′) being separated by a gap (12); and
a tongue (7) integrally formed with the housing (11), the tongue (7) bridging the gap (12);
wherein the plurality of perforations (2) include axially running slots (3) defining residual intervening webs (8), and wherein the webs form a crumple zone.

10. The apparatus as claimed in claim 9, wherein the slots (3) have rounded opposite ends.

11. The apparatus as claimed in claim 10, wherein the slots (3) are oval in configuration.

12. The apparatus as claimed in claim 9, wherein the slots (3) and the webs (8) are provided over the entire circumference of the housing (11).

13. The apparatus as claimed in claim 9, wherein the slots (3) are wider than the intervening webs (8).

14. The apparatus as claimed in claim 9, wherein the flat strip of material is a flat strip of spring steel.

15. The apparatus as claimed in claim 9, further comprising a pair of locking bolts (13, 13′) respectively received by the pair of tightening straps (9, 9′) and arranged axially parallel to each other.

16. The apparatus as claimed in claim 15, further comprising at least one clamping screw (14) connected to the pair of locking bolts (13, 13′).

17. The apparatus as claimed in claim 9, wherein the pair of tightening straps (9, 9′) are integrally connected to the housing (11).

18. A process for manufacturing a tube coupling apparatus for connecting smooth-ended tubes, the process comprising the steps of:
punching a plurality of perforations (2) along the length of a continuous strip of material (1);
making a pair of openings (5, 5′) through the strip of material, the openings (5, 5′) being spaced longitudinally from one another by a distance appropriate for a desired diameter of the tube coupling apparatus;
cutting the strip of material (1) to a desired length;
shaping the strip of material (1) to include a circular loop (6);
deforming the circular loop (6) to provide two opposing, mutually connected straps (9, 9′); and
rounding a portion of the strip of material to form a substantially cylindrical housing (11) for receiving the smooth-end tubes.

19. The process as claimed in claim 18, further comprising the step of joining a top portion of the circular loop (6) to a bottom portion of the circular loop (6) when the circular loop (6) is deformed to thereby form a connecting point (10) of the two straps (9, 9′).

20. The process as claimed in claim 19, wherein the step of joining is performed by resistance welding.

21. The process as claimed in claim 20, wherein the step of joining is performed by spot welding.
